(19) United States
(12) Patent Application Publication
(10) Pub. No.: US 2006/0235704 A1
(43) Pub. Date: Oct. 19, 2006

(54) America & Europe reputation membership for overseas companies, enterprises, manufacturers, representatives

(76) Inventor: Henri Duong, Rosemead, CA (US)

Correspondence Address: Henri Duong, 316 1/2 E Glendon Way, Alhambra, CA, 91801, US

(21) Appl. No.: 10/669,668

(22) Filed: Sep. 23, 2003

(51) Int. Cl. G06Q 99/00

(52) U.S. Cl. 705/1

(57) ABSTRACT

America & Europe reputation membership policy is created to augment reputation of overseas membership manufacturers, enterprises, companies, representatives in their own countries, its value is over a traditional advertisement, its purposes are to make their companies famous in business and to collect taxes by local government.

### CROSS-REFERENCE TO RELATED APPLICATIONS

Disclosure Document Deposit Request; Disclosure Document No: 528589 date: Mar. 31, 2003 PTO-1652 (8/99)

### STATEMENT REGARDING FEDERALLY SPONSORED RESEARCH

“Not Applicable”

### REFERENCE TO A MICROFICHE APPENDIX

“Not Applicable”

### BACKGROUND OF THE INVENTION

The United States of America is a leading country in the world while Europe is a western industrial continent; American space voyage and European airbus signify advanced technology, reputation of America & Europe is well appreciated by foreign countries all over the world so I create America & Europe reputation membership association for overseas manufacturers, enterprises, companies, representatives to admire reputation of the United States & Europe through that value to benefit their business activities.

FIG. 3: The policy builds to authorize overseas membership companies to use annual America & Europe reputation membership emblems in their letterheads, catalogs augmenting their business reputation. The membership reputation policy is to license uniquely for overseas companies without handling business transaction to be considered as a policy invention that no other companies do such a way, its aim is to make overseas companies famous in their own business.

### BRIEF SUMMARY OF THE INVENTION

Advantages of the invention are to promote business for overseas companies and to collect taxes by local government on activity of the association. FIG. 5: American & European reputation for overseas policy does increase reputation of membership companies in their own countries, minimum investment 1 earns top value of reputation 2 thus up raising their business activities.

The invention composes of membership association/company, its function, emblems, membership statements, using of America & Europe membership emblems for overseas companies, enterprises, manufacturers, representatives in their letterheads, catalogs office machineries; computers, printers, scanners, copiers, fax machines, telephones and requirements of business office.

### BRIEF DESCRIPTION OF THE DRAWINGS

FIG. 1; U.S. & Europe reputation membership activity.

FIG. 2; Overseas companies

FIG. 3; Assessment in two periods.

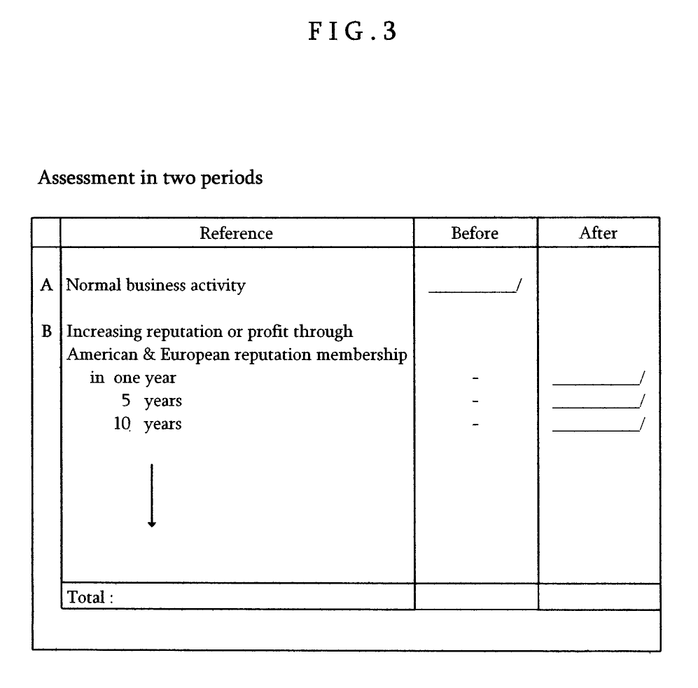

FIG. 4; Reputation of overseas companies.

FIG. 5; Minimum investment earns top reputation.

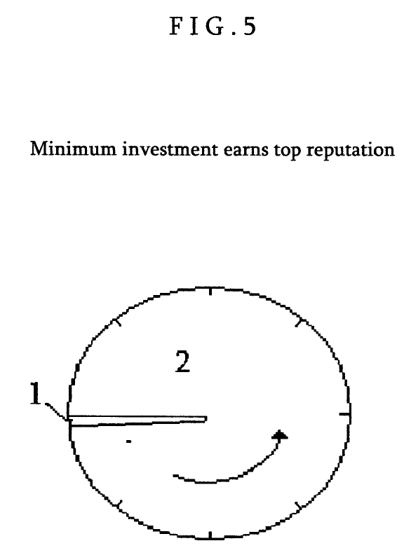

FIG. 6; Its value evaluates over a traditional advertisement.

### DETAILED DESCRIPTION OF THE INVENTION

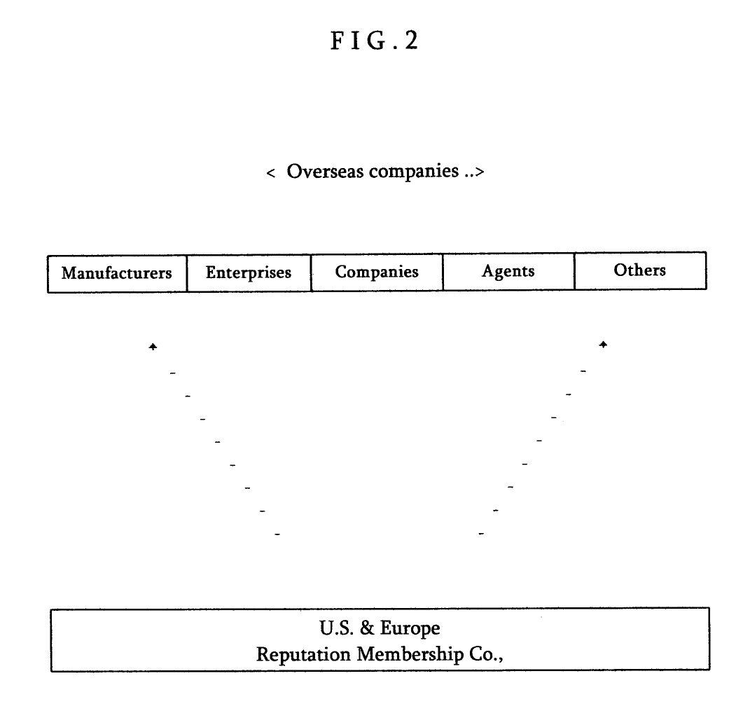

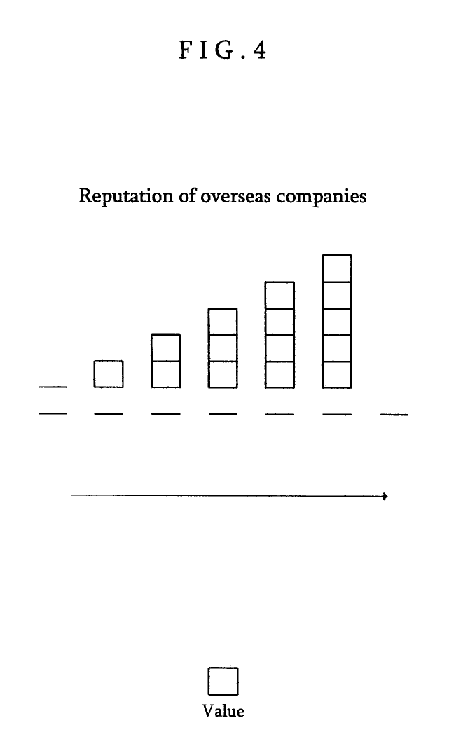

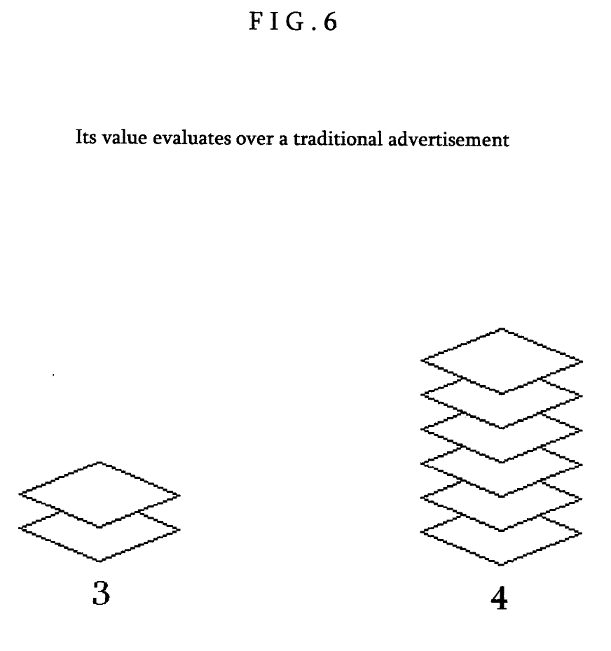

FIG. 2: U.S. & Europe reputation membership association for overseas manufacturers, enterprises, companies, representatives owns its fundamental policy and structure. It is created to license uniquely reputation value of America & Europe to overseas companies in foreign countries without business transaction so as to increase their reputation FIG. 4. Its value 4 evaluates over a traditional advertisement 3 in FIG. 6.

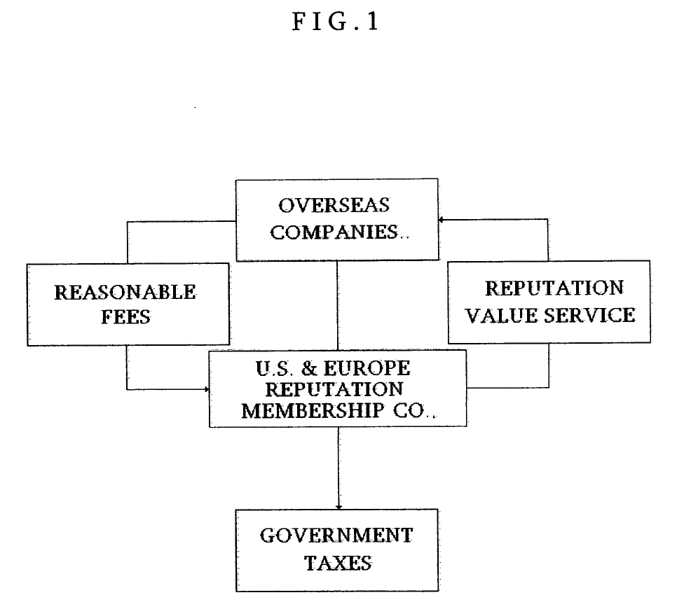

FIG. 1: This is a pure membership reputation policy licensing uniquely for foreign companies in exchange of reasonable annual fees to be paid by overseas companies to the service association maintaining their membership to obtain membership statements, using of annual America & Europe reputation emblems. The creative association functions with overseas members in such a different nature that normal domestic membership associations do not have the identical activities.

Exchanging value of America & Europe reputation, U.S. & Europe reputation association will authorize in annual membership statements that overseas enterprises, manufacturers, companies, representatives use annual America & Europe reputation membership emblems adding to their letterheads, catalogs. The association will furnish certain information address of local manufacturers and trading companies upon request.

There is no any business transaction associated between America & Europe reputation membership association and overseas membership companies, the association takes no responsibility on any activities of membership companies in the policy. Its goal is to make overseas companies become famous through America & Europe reputation value.

1. What I claim as my invention is: America & Europe reputation membership association licenses the value of its reputation uniquely to overseas manufacturers, enterprises, companies, representatives to use America & Europe reputation membership emblems in their letters-head, catalogs for exchange of reasonable annual membership fees to be paid by these companies to the association without handling business transaction.

2. What I claim as my invention is: The elements and structure of U.S. & Europe reputation membership association or any other companies with the same policy; modification of the structure to the same effect, contents as well as illustrations of the invention in these documents, the invention composes of business company, function of this policy, overseas manufacturers, enterprises, representatives, companies . . . , membership statements, America & Europe reputation membership emblems or equivalents, office machineries; computers, scanners, copiers, fax machines, telephones and necessary requirements of business office.

3. What I claim as my invention is: Combining America & Europe reputation membership reputation licensing to foreign manufacturers, enterprises, companies, representatives etc., with any other systems, policies etc using other names functioning to the same effect, overseas companies including foreign manufacturers, enterprises, companies, representatives, business groups, organizations and any other business with employees etc., membership emblems including membership hallmarks, symbols, badges, seals, signs, representations, logos, stamps, marks, trademarks, flags, figures, token etc., membership statements including membership certificates, statements, authorizations, and any other business documents etc., the invention be used everywhere.
